(19) United States
(12) Patent Application Publication
(10) Pub. No.: US 2026/0308928 A1
(43) Pub. Date: Oct. 8, 2026

(54) SAFETY SYSTEM

(71) Applicant: SERVICE STREAM MAINTENANCE PTY LTD, Melbourne (AU)

(72) Inventor: Michael Bruce MARTIN, Melbourne (AU)

(21) Appl. No.: 19/480,655

(22) PCT Filed: May 2, 2024
(86) PCT No.: PCT/AU2024/050425

§ 371 Date: Oct. 31, 2025

(30) Foreign Application Priority Data
May 3, 2023 (AU) 2023202769

(51) Int. Cl. E04G 21/32; E04H 12/00

(52) U.S. Cl. CPC E04G 21/3266; E04H 12/00

(57) ABSTRACT

A safety system for arresting falling objects about a monopole is provided, the monopole being fixed to a surface. The system comprises a structure having a mesh and an adjustable supporting body arrangeable about a periphery of the mesh, and a mounting arrangement configured to mount the structure about the monopole and above the surface.

### TECHNICAL FIELD

The present disclosure relates, generally, to systems for arresting falling objects and, more particularly, to a safety system for arresting falling objects about a monopole fixed to a surface.

### BACKGROUND

Infrastructure supported by monopoles such as overhead transmission lines and telecommunication equipment, including mobile or cell phone towers having antennas, require ongoing maintenance to function effectively and consistently. Such maintenance requires a technician to perform maintenance work proximate the top of these monopoles where various equipment is mounted. To perform this maintenance work, the technician requires the use of various tools and may be required to remove components mounted to the monopole for replacement.

The maintenance process therefore poses a risk of objects, such as tools or equipment removed from the monopole, falling from proximate the top of the monopole where the technician is performing the maintenance. These falling objects can cause injuries or death if they strike a person located in the vicinity of the base of the monopole.

One option to inhibit injuries or death is to define a zone of a predetermined distance from the base of the monopole that is only accessible by authorised personnel, thereby providing an exclusion zone in which objects are able to fall about the monopole with a greatly reduced risk of these objects striking a person or otherwise doing harm.

However, land leases secured for monopole installations are usually in awkward locations which may encroach onto neighbouring land, thereby making such exclusion zones difficult and/or costly to implement, or even impossible to implement in some cases.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

In an aspect of the present disclosure, there is provided a safety system for arresting falling objects about a monopole, the monopole being fixed to a surface, the system comprising: a structure having a mesh and an adjustable supporting body arrangeable about a periphery of the mesh; and a mounting arrangement configured to mount the structure about the monopole and above the surface.

The supporting body may be inflatable. The supporting body may be in the form of an inflatable tube having ends connectable to each other. The ends of the tube may bear against each other.

The mesh may be flexible. The mesh may define openings having a maximum dimension of less than about 10 millimetres. The mesh may be releasably connectable to the adjustable supporting body via, for example, a zip fastener.

The mesh may comprise a first periphery and a second periphery spaced from the first periphery by a pair of opposed ends, the first periphery being releasably connectable to the supporting body, and the second periphery being mountable about the monopole below the supporting body. The opposed ends of the mesh may be releasably connectable to each other via, for example, a zip fastener, and the zip fastener may be operable towards the second periphery of the mesh to connect the opposed ends to each other. The structure may be mountable about the monopole and above the surface such that the mesh is substantially loose proximate the second periphery.

The mounting arrangement may comprise at least one collar arrangeable about the monopole and connectable to the structure. In an embodiment, the mounting arrangement may comprise one collar connectable to the supporting body and arrangeable about the monopole at a position along the monopole substantially in register with the supporting body. In another embodiment, the mounting arrangement may comprise two collars connectable to the supporting body and arrangeable about the monopole at respective spaced positions along the monopole, one of the respective spaced positions being substantially in register with the supporting body and the other of the respective spaced positions being either: above the supporting body, or below the supporting body. In another embodiment, the mounting arrangement may comprise three collars, two of the three collars being connectable to the supporting body and one of the three collars being connectable to the mesh, and the three collars may be arrangeable about the monopole at respective spaced positions along the monopole, one of the respective spaced positions being above the supporting body, another one of the respective spaced positions being substantially in register with the supporting body, and the other of the respective spaced positions being below the supporting body.

The mounting arrangement may comprise at least one sling having a connected end, a free end and an eyelet, the at least one sling being connected to the supporting body or the mesh at the connected end and configured to be arranged about the monopole such that the free end passes through the eyelet. The system described above may further comprise a shielding portion connectable along a periphery of the supporting body. The supporting body may comprise anchoring portions for connecting a hoisting mechanism to raise at least the supporting body above the surface.

In another aspect of the present disclosure, there is provided a method of installing a safety system to a monopole for arresting falling objects about the monopole, the monopole being fixed to a surface, the method comprising: positioning a structure of the safety system about the monopole, the structure having a mesh and an adjustable supporting body arranged about a periphery of the mesh; and mounting the structure about the monopole and above the surface using a mounting arrangement of the safety system.

The supporting body may be inflatable, and the method described above may further comprise inflating the supporting body. The supporting body may be in the form of an inflatable tube, and the positioning the structure about the monopole may comprise connecting ends of the inflatable tube to each other about the monopole.

The positioning the structure about the monopole may comprise positioning at least the supporting body about the monopole. The mounting the structure about the monopole may comprise mounting at least the supporting body about the monopole.

The method described above may further comprise attaching the mesh to the supporting body using a zip fastener. The mesh may comprise a first periphery and a second periphery spaced from the first periphery by a pair of opposed ends, and the positioning the structure about the monopole may comprise releasably connecting the first periphery to the supporting body, and the mounting the structure about the monopole and above the surface may comprise mounting the second periphery about the monopole below the supporting body. The positioning the structure about the monopole may comprise connecting the opposed ends of the mesh to each other by operating a zip fastener towards the second periphery of the mesh. The mounting the second periphery about the monopole may comprise mounting the second periphery about the monopole such that the mesh is substantially loose proximate the second periphery.

The mounting arrangement may comprise at least one collar, and the mounting the structure about the monopole and above the surface may comprise connecting the at least one collar to the structure and arranging the at least one collar about the monopole. In an embodiment, the mounting arrangement may comprise one collar, and the connecting the at least one collar to the structure may comprise connecting the one collar to the supporting body, and the arranging the at least one collar about the monopole may comprise arranging the one collar about the monopole at a position along the monopole substantially in register with the supporting body. In another embodiment, the mounting arrangement may comprise two collars, and the connecting the at least one collar to the structure may comprise connecting the two collars to the supporting body, and the arranging the at least one collar about the monopole may comprise arranging the two collars at respective spaced positions along the monopole, one of the respective spaced positions being substantially in register with the supporting body and the other of the respective spaced positions being either: above the supporting body, or below the supporting body. In another embodiment, the mounting arrangement may comprise three collars, and the connecting the at least one collar to the structure may comprise connecting two of the three collars to the supporting body and connecting one of the three collars to the mesh, and the arranging the at least one collar about the monopole may comprise arranging the three collars at respective spaced positions along the monopole, one of the respective spaced positions being above the supporting body, another one of the respective spaced positions being substantially in register with the supporting body, and the other of the respective spaced positions being below the supporting body.

The mounting the structure about the monopole and above the surface may comprise raising at least the supporting body above the surface. The supporting body may comprise anchoring portions, and the raising the structure above the surface may comprise connecting a hoist to the anchoring portions for raising at least the supporting body above the surface. The method described above may further comprise connecting a shielding portion along a periphery of the supporting body.

The mounting arrangement may comprise at least one sling having a connected end, a free end and an eyelet, the at least one sling being connected to the supporting body or the mesh at the connected end, and the mounting the structure about the monopole and above the surface may comprise arranging the at least one sling about the monopole such that the free end passes through the eyelet.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure will now be described by way of example only with reference to the accompanying drawings in which:

FIG. 1 shows a perspective view of an embodiment of a safety system;

FIG. 2 shows a perspective view of the safety system shown in FIG. 1 having another embodiment of the mounting arrangement and the mesh not being shown;

FIG. 3 shows a top view of the safety system shown in FIG. 1;

FIG. 4 shows an enlarged view of a portion of FIG. 3 encircled by the circle A;

FIG. 5 shows a schematic of another embodiment for connecting the ends of the supporting body shown in FIGS. 1-4;

FIG. 6 shows a schematic of the mesh shown in FIGS. 1 and 3;

FIG. 7 shows a schematic of an alternative embodiment of the mesh shown in FIG. 6;

FIG. 8 shows a sectional view of a shielding portion of the safety system shown in FIGS. 1-7;

FIG. 9 shows a flowchart of an embodiment of a method of installing the safety system shown in FIGS. 1-7 to a monopole; and

FIG. 10 shows a flowchart of another embodiment of a method of installing the safety system shown in FIGS. 1-7 to a monopole.

### DESCRIPTION OF EMBODIMENTS

In the drawings, reference numeral 10 designates a safety system 10 for arresting falling objects about a monopole 12, the monopole 12 being fixed to a surface (not shown). The system 10 comprises a structure 18 having a mesh 14 and an adjustable supporting body 16 arrangeable about the mesh 14, and a mounting arrangement 20 configured to mount the structure 18 about the monopole 12 and above the surface.

It will be understood that the term “adjustable” is to be interpreted broadly to define a component that is configured to be altered and/or moved in any way to achieve a desired result. Thus, the adjustable supporting body 16 may be in the form of a flexible member which is able to be shaped in order to be arranged about the mesh 14, for example, steel wire. As another example, the adjustable supporting body 16 may also be formed from a plurality of connected links that are able to be arranged about the mesh 14. It will also be understood that the mesh 14 and the adjustable supporting body 16 may be provided as separate components.

In the illustrated embodiment, the adjustable supporting body 16 is inflatable. In particular, the supporting body 16 is in the form of an inflatable tube 22 having ends 24, 26 releasably connectable to each other. The inflatable tube 22 may be formed from any suitable inflatable material, such as plastic including polyethylene.

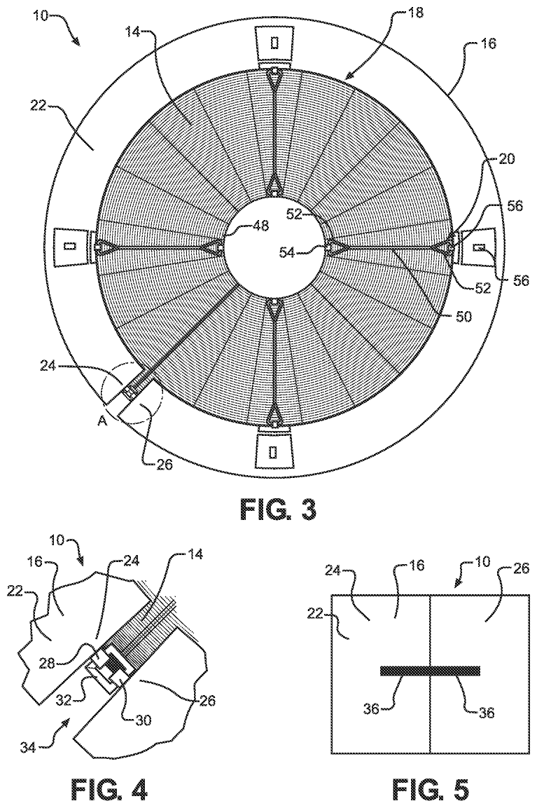

An example of a means of releasably connecting the ends 24, 26 of the tube 22 to each other is shown in FIG. 4, which is an enlarged view of the portion of FIG. 3 encircled by the circle A. In this example, each end 24, 26 of the tube 22 includes a respective receiving formation 28, 30 which receives a portion of a coupling member 32 in the form of a metal ring. In this example, the receiving formations 28, 30 are configured to apply tension to the coupling member 32 which resists the tension, thereby connecting the ends 24, 26 of the tube 22 to each other while maintaining a gap 34 between the ends 24, 26 as shown in FIG. 4.

Another example of a means of releasably connecting the ends 24, 26 of the tube 22 to each other is shown in FIG. 5. In this example, the ends 24, 26 are connected to each other by straps 36 attached to each end 24, 26 which are connectable to each other by a fastening means (not shown), such as a clasp, a hook and loop fastener, a buckle, such as a snap-fit buckle, a clip, such as a nylon clip, and the like. In some embodiments, the straps 36 are attached to each end 24, 26 by welding the straps to the tube 22. In this example, each pair of straps 36 is configured to apply tension to the fastening means which resists the tension, thereby connecting the ends 24, 26 of the tube 22 to each other such that the ends 24, 26 of the inflatable tube 22 bear against each other or are in contact with each other as shown in FIG. 5. In this embodiment, when the ends 24, 26 of the tube 22 are connected to each other, the supporting body 16 forms a substantially circular shape. The straps 36 are circumferentially spaced about the ends 24, 26 of the inflatable tube 22 in this embodiment for improving the equal distribution of force about the ends 24, 26. The straps 36 may instead be connected to one of the ends 24, 26, and one or more respective releasable locking means, such as a buckle, may be connected to the other of the ends 24, 26 in order to connect to the straps 36. In some embodiments, four straps 36 may be provided, however, any suitable number of straps 36 may be provided in other embodiments.

In some embodiments, the ends 24, 26 of the tube 22 are connectable to bear against each other such that a frictional force between the ends 24, 26 is not too high such as to damage the ends 24, 26 and eventually cause a rupture of the tube 22. The frictional force between the ends 24, 26 is also affected by an inflation pressure of the tube 22, since a higher than recommended inflation pressure will cause the ends 24, 26 of the tube 22 to expand above a safe amount, thereby increasing the frictional force between the ends 24, 26.

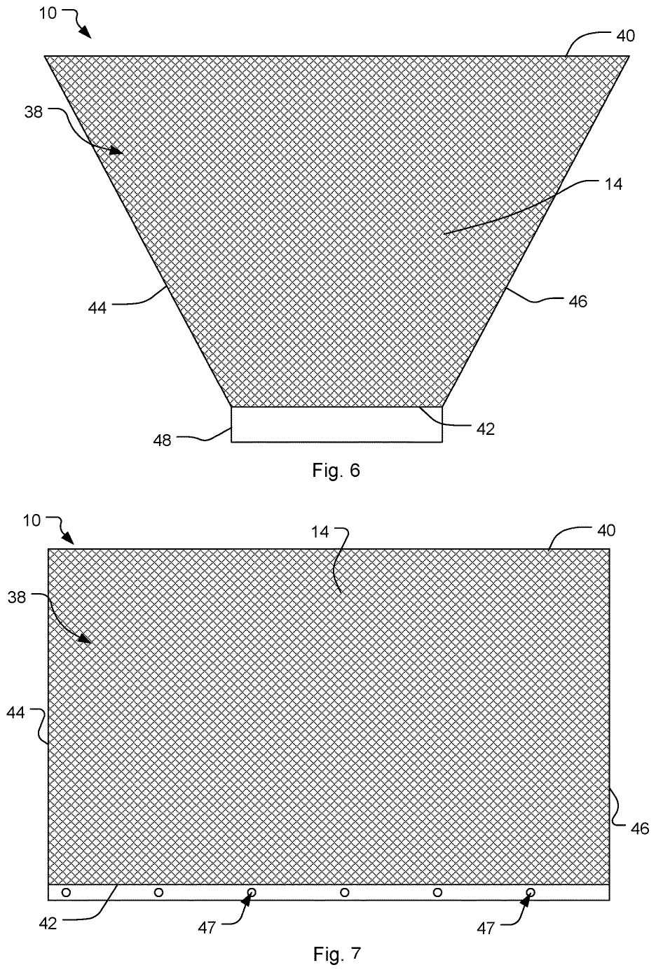

The mesh 14 will be discussed with reference to FIG. 6 where the mesh is laid out flat. In the illustrated embodiments, the mesh 14 is flexible, for example, by being formed from a braided flexible material such as polyethylene, however, it will be understood that in other embodiments the mesh 14 may be substantially rigid, for example, by being formed from metal or hard plastic. In some embodiments, the mesh 14 defines openings 38 having a maximum dimension of less than about 10 millimetres, and, more particularly, the openings 38 have a maximum dimension of between about 3 millimetres and about 8 millimetres. The openings 38 are thereby sized to be small enough to arrest larger falling objects such as tools as well as smaller falling objects such as nuts and bolts, and large enough to withstand environmental conditions, for example, to allow wind and rain to pass through the openings 38 such that the mounting of the mesh 14 and the structure 18 as a whole about the monopole 12 and above the surface is maintained.

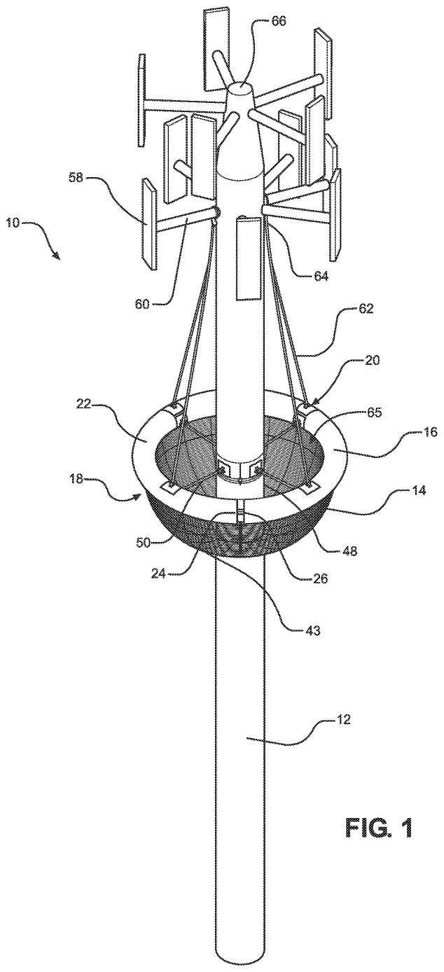

The mesh 14 of FIG. 6 is laid flat and comprises a first periphery 40 and a second periphery 42 spaced from the first periphery 40 by a pair of opposed ends 44, 46. The first periphery 40 is releasably connectable to the supporting body 16, and the second periphery 42 is mountable about the monopole 12 below the supporting body 16. The structure 18 is mountable about the monopole 12 such that when the structure 18 is mounted, the diameter of the circle made by the first periphery 40 is wider that the circle formed by the second periphery 42. In some embodiments, the first periphery 40 is releasably connectable to the supporting body 16 via a zip fastener (not shown). In the illustrated embodiments, the structure 18 collects around the monopole 12 to form a bowl shape with the base of the bowl indicated at 43 (FIG. 1) closer to the surface (lower) than the second periphery 42. Preferably, the structure 18 is mountable about the monopole 12 and above the surface such that the mesh 14 is substantially loose proximate the second periphery 42. In other words, the mesh 14 proximate the second periphery 42 hangs or sags such that the base 43 is below a portion along the length of the monopole 12 to which the second periphery 42 of the mesh 14 is mounted. The substantially loose mesh 14 may inhibit a bouncing effect which may be provided by a taut, flexible mesh 14, whereby falling objects strike the mesh 14 and are deflected away from the mesh 14 and possibly over the supporting body 16 towards the surface below. Instead, the substantially loose mesh 14 may absorb the force of a falling object such that the object is not deflected over the supporting body 16 towards the surface below by the mesh 14.

The opposed ends 44, 46 of the mesh 14 are releasably connectable to each other via a zip fastener (not shown). The zip fastener is operable towards the second periphery 42 of the mesh 14 to connect the opposed ends 44, 46 to each other, such that a user climbing the monopole is able to disconnect the opposed ends 44, 46 from each other by operating the zip fastener towards the first periphery 40 or upwards. In this way, the user is able to pass through the mesh 14 safely without having to reach the first periphery 40 in order to operate the zip fastener to disconnect the opposed ends 44, 46. It will be understood that in other embodiments, the mesh 14 may be formed from a plurality of mesh panels releasably connectable to each other via zip fasteners in order to provide a plurality of zip fasteners disposed about the monopole 12 which are able to be operated by a user to conveniently pass through the mesh 14 at more than one location about the monopole.

FIG. 7 shows a schematic of an alternative embodiment of the mesh 14 laid flat in which like reference numerals refer to like features with respect to the mesh 14 shown in FIG. 6. In FIG. 7, the mesh 14 is a rectangular shape as opposed to a trapezoidal shape of the mesh 14 in FIG. 6 and defines eyelets 47 at the second periphery 42 for receiving webbing to tie or attach or position or secure the second periphery 42 of the mesh 14 about or around the monopole 12. The rectangular shape of the mesh 14 allows the mesh 14 proximate the second periphery 42 to be substantially looser when the safety system 10 is installed to the monopole 12 compared to the embodiment of the mesh shown in FIG. 6 due to a greater surface area of the mesh 14 in FIG. 7. In other embodiments of the mesh 14, the eyelets 47 may be defined in the trapezoidal-shaped mesh 14 as shown in FIG. 6.

Example embodiments of the mounting arrangement 20 are shown in FIGS. 1, 2 and 6. In the illustrated embodiments, the mounting arrangement 20 comprises at least one collar 48 arrangeable about the monopole 12 and releasably connectable to the structure 18. The collar 48 may be formed from a flexible material, such as a flexible plastic, or may be formed from metal, such as a metal that is deformable to be arranged about the monopole 12. The collar 48 is securable about the monopole 12 using a fastener (not shown), such as a strap disposed within a pocket provided along a periphery of the collar 48 and a buckle at one end of the pocket to receive and secure the strap. It will be understood that any suitable fastener may be used to secure the collar 48 about the monopole 12, such as a snap-fit buckle, a clasp, a clip, a pin and hole arrangement, and the like.

FIG. 1 shows an embodiment of the mounting arrangement 20 comprising one collar 48 connectable to the supporting body 16 and arrangeable about the monopole 12 at a position along the length of the monopole 12 substantially in register with the supporting body 16. The one collar 48 is in register with the supporting body 16 in order to provide support to the structure 18 in a radial direction in the event of environmental conditions such as wind. The term “substantially in register with the supporting body 16” will be understood to mean substantially aligned or coplanar with the supporting body 16, or to be at substantially the same height above the surface as the supporting body 16. It will also be understood that the structure 18 is mountable above the surface by the mounting arrangement 20 such that only the monopole 12 is supporting the structure 18 above the surface and such that the surface is not directly supporting the structure 18, which provides space for people to walk near the monopole 12 and underneath the structure 18 mounted to the monopole 12 safely.

The one collar 48 is connected to the supporting body 16 in FIG. 1 by a first set of straps 50 having looped ends 52, which pass through looped connectors 54 provided on the collar 48 and looped connectors 56 provided on the supporting body 16. In some embodiments, releasable connectors (not shown) may be attached to each of the looped connectors 54, 56 in order for each releasable connector to receive one of the looped ends 52 of the straps 50. The releasable connectors allow for the straps 50 to be provided as separate, releasably connectable components and the releasable connectors may be in the form of a pair of aligned, threaded, spaced holes joined by a substantially C-shaped portion and configured to receive a threaded member in order to form a loop defined by the threaded member and the substantially C-shaped portion. In some embodiments, the straps 50 and looped connectors 54, 56 are formed from a woven material and the releasable connectors are formed from metal and/or plastic, for example, the C-shaped portion defining the aligned, threaded, spaced holes may be formed from metal and the threaded member may be formed from plastic or metal.

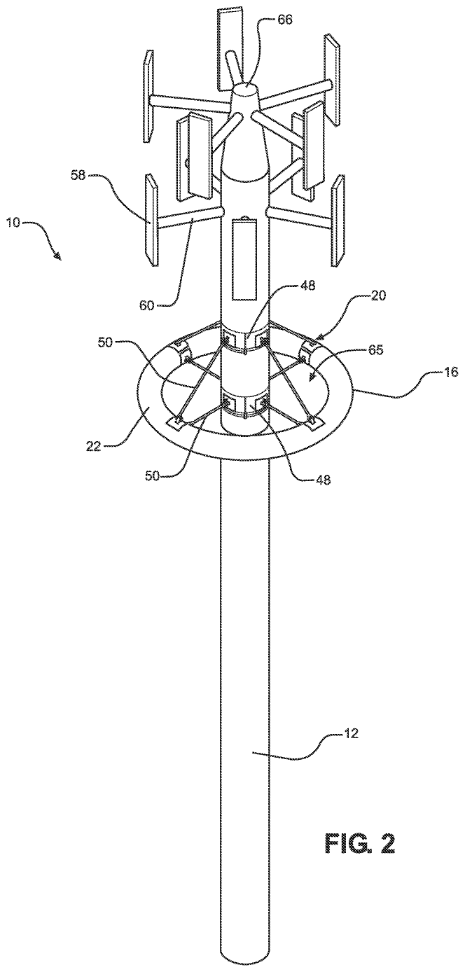

The monopole 12 as illustrated in FIGS. 1 and 2 forms a part of a mobile phone tower or cell tower having a plurality of antennas 58 each mounted to the monopole 12 by a rod 60. The mounting arrangement 20 shown in FIG. 1 also comprises a second set of straps 62 each connected to the supporting body 16 in a similar manner as the first set of straps 50 described above, and connected to one of the rods 60 by being fastened around the rod 60. The straps 62 may each comprise a sling 64 at the end of the strap 62 connectable to the rod 60 comprising a free end and an eyelet (not shown), whereby the free end is passed around the rod 60 and through the eyelet to connect the strap 62 to the rod 60. In this way, the second set of straps 62 provide support to the structure 18 in the operatively vertical direction by assisting to suspend the structure 18 above the surface. It will be understood that the monopole 12 is not limited to forming a part of a mobile phone tower or cell tower, and may form a part of any suitable structure, such as those used for telecommunication, electrical transmission, construction, manufacturing, and the like.

The mounting arrangement 20 shown in FIG. 1 also comprises at least one sling (not shown) having a connected end, a free end and an eyelet, the at least one sling being connected to the mesh 14 at the connected end and configured to be arranged about the monopole 12 such that the free end passes through the eyelet. In this embodiment, the at least one sling is connected to the second periphery 42 of the mesh 14 at the connected end and is wrapped around or chokes the monopole 12 via the free end and the eyelet in order to mount the mesh 14 to the monopole 12, and in particular, to mount the second periphery 42 of the mesh 14 to the monopole 12. In this way, the at least one sling provides support to the structure 18 in the operatively radial direction by inhibiting gaps being formed between the mesh 14 and the monopole 12. Further, the at least one sling is beneficial in applications whereby the monopole 12 comprises a cable tray (not shown) extending along the monopole 12, by being arrangeable about the monopole 12 through a gap provided between the cable tray and the monopole 12. In other embodiments, the second set of straps 62 attached to the rods 60, in combination with either the at least one sling connected to the second periphery 42 of the mesh 14 or the eyelets 47 defined at the second periphery 42 of the mesh 14 as described above, form the mounting arrangement 20 without the at least one collar 48.

It will be understood that the at least one sling choking the monopole 12 may also be provided at a position along the monopole 12 in register with the supporting body 16 instead of the collar 48 and the first set of straps 50, and/or may also be provided above the supporting body 16 instead of the second set of straps 62. In this way, there are embodiments of the mounting arrangement 20 including no collars and only the at least one sling being provided at positions along the monopole 12 above the supporting body 16, in register with the supporting body 16, and/or below the supporting body 16. In other embodiments, a combination of the at least one sling and the at least one collar 48 are provided to mount the structure 18 about the monopole 12 and above the surface. It will also be understood that the at least one sling and the second set of straps 62 may be omitted and replaced with collars 48 provided at positions along the monopole 12 above the supporting body 16, in register with the supporting body 16, and/or below the supporting body 16 as discussed in greater detail below.

FIG. 2 shows an embodiment of the mounting arrangement 20 comprising two collars 48 connectable to the supporting body 16 and arrangeable about the monopole 12 at respective spaced positions along the monopole 12, with the mesh 14 not being shown for clarity. One of the respective spaced positions is substantially in register with the supporting body 16 and the other of the respective spaced positions is above the supporting body 16. However, it will be understood that the other of the respective spaced positions may instead be below the supporting body 16. In this embodiment, the two collars 48 are connected to the supporting body 16 and arranged about the monopole in the same manner as for the single collar 48 discussed above, and the mesh 14 would be mounted to the monopole 12 using the at least one sling in the same manner as discussed above if the mesh 14 was shown in FIG. 2. In other embodiments, the collar 48 arrangeable along the monopole 12 and above the supporting body 16, in combination with either the at least one sling connected to the second periphery 42 of the mesh 14 or the eyelets 47 defined at the second periphery 42 of the mesh 14 as described above, form the mounting arrangement 20.

FIG. 6 shows an embodiment of the mesh 14 comprising a collar 48 connected to the mesh 14 at the second periphery 42. The collar 48 connected to the mesh 14 may be releasably connectable, for example, via a zip fastener, or may be integral with the mesh 14. Combining this embodiment of the mounting arrangement 20 having a collar 48 connected to the mesh 14 with the embodiment of the mounting arrangement 20 shown in FIG. 2 with the at least one sling omitted, provides an embodiment of the mounting arrangement 20 comprising three collars 48, two of the three collars 48 being connectable to the supporting body 16 and one of the three collars 48 being connectable to the mesh 14. The three collars 48 are arrangeable about the monopole 12 at respective spaced positions along the monopole 12, one of the respective spaced positions being above the supporting body 16, another one of the respective spaced positions being substantially in register with the supporting body 16, and the other of the respective spaced positions being below the supporting body 16. In this embodiment, the collars 48 are connected to the supporting body 16 and arranged about the monopole in the same manner as discussed above.

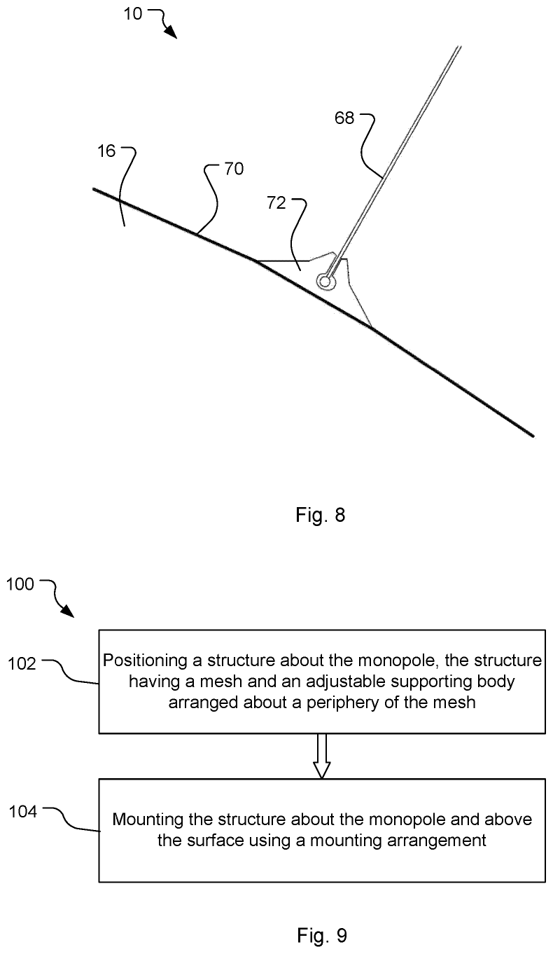

In some embodiments, the safety system 10 further comprises a shielding portion 68 connectable along a periphery 70 of the supporting body 16 as shown in FIG. 8. The shielding portion 68 is connectable to the periphery 70 of the supporting body 16 by sliding the shielding portion 68 along a guide member 72 formed on the periphery 70 of the supporting body 16. In some embodiments, the shielding portion 68 is flexible to increase the ease of connecting the shielding portion 68 to the periphery 70 of the supporting body 16. In other embodiments, the shielding portion 68 may be integrally formed with the supporting body 16, or may be connectable to the periphery 70 of the supporting body 16 using a fastener, an adhesive, or the like. The shielding portion 68 provides an additional barrier to increase the overall height and/or diameter of the supporting body 16 in order to inhibit objects from deflecting away from the mesh 14 and over the supporting body 16 towards the surface below.

In some embodiments, the supporting body 16 comprises anchoring portions for connecting a hoisting mechanism (not shown) to raise at least the supporting body 16 above the surface. The looped connectors 54 for connecting to the second set of straps 62 as shown in FIG. 1 may be used as the anchoring portions, and the hoisting mechanism may be in the form of one or more lifting straps (not shown) connectable the anchoring portions at a first end and passing proximate a top 66 of the monopole 12, such as around one or more pulleys connected to the rod/s 60, to be reached by the user on the surface for pulling on the one or more lifting straps to raise at least the supporting body 16 above the surface. In some embodiments, the one or more lifting straps pass through a hole 65 defined by the inflatable tube 22 connected at its ends 24, 26 and towards the surface below to be reached a user to be able raise at least the supporting body 16 above the surface. The hoisting mechanism also allows a user to lower at least the supporting body 16 from the monopole 12 once the structure 18 has been dismounted from about the monopole 12. It will be understood that the anchoring portions may be provided as separate features (not shown) to the looped connectors 54, and that the hoisting mechanism and anchoring portions are configured to raise either the supporting body 16 above the surface alone, or with one or both of the mesh 14 and the mounting arrangement 20 connected thereto.

FIG. 9 shows a flowchart of an embodiment of a method 100 of installing the safety system 10 to the monopole 12. The method 100 comprises positioning 102 the structure 18 of the safety system 10 about the monopole 12, the structure 18 having the mesh 14 and the adjustable supporting body 16 arranged about a periphery of the mesh 14. The method 100 further comprises mounting 104 the structure 18 about the monopole 12 and above the surface using the mounting arrangement 20 of the safety system 10. It will be understood that the positioning 102 may be implemented before or after the mounting 104.

In embodiments whereby the supporting body 16 is inflatable, the method 100 comprises inflating the supporting body 16. In embodiments whereby the supporting body 16 is in the form of the inflatable tube 22, the positioning 102 comprises connecting the ends 24, 26 of the inflatable tube 22 to each other about the monopole 12 such that the ends 24, 26 of the tube 22 bear against each other. It will be understood that in other embodiments, the positioning 102 may comprise connecting ends 24, 26 of the tube 22 to each other using the coupling member 32 as described above.

In some embodiments, the positioning 102 the structure 18 about the monopole 12 comprises releasably connecting the first periphery 40 of the mesh 14 to the supporting body 16. In some embodiments, the mounting 104 the structure 18 about the monopole 12 and above the surface comprises mounting the second periphery 42 of the mesh 14 about the monopole 12 below the supporting body 16. The mesh 14 proximate the second periphery 42 hangs or sags 43 below a portion along the length of the monopole 12 to which the second periphery 42 of the mesh 14 is mounted. In some embodiments, the positioning 102 the structure 18 about the monopole 12 comprises connecting the opposed ends 44, 46 of the mesh 14 to each other by operating the zip fastener towards the second periphery 42 of the mesh 14. In some embodiments, the mounting the second periphery 42 about the monopole 12 comprises mounting the second periphery 42 about the monopole 12 such that the mesh 14 is substantially loose proximate the second periphery 42.

In embodiments whereby the mounting arrangement 20 comprises the at least one collar 48, the mounting 104 the structure 18 about the monopole 12 and above the surface comprises connecting the at least one collar 48 to the structure 18 and arranging the at least one collar 48 about the monopole 12. In embodiments of the mounting arrangement 20 comprising one collar 48, the connecting the at least one collar 48 to the structure 18 comprises connecting the one collar 48 to the supporting body 16, and the arranging the at least one collar 48 about the monopole 12 comprises arranging the one collar 48 about the monopole 12 at a position along the monopole 12 substantially in register with the supporting body 16.

In embodiments of the mounting arrangement 20 comprising two collars 48, the connecting the at least one collar 48 to the structure 18 comprises connecting the two collars 48 to the supporting body 16, and the arranging the at least one collar 48 about the monopole 12 comprises arranging the two collars 48 at respective spaced positions along the monopole 12, one of the respective spaced positions being substantially in register with the supporting body 16 and the other of the respective spaced positions being either: above the supporting body 16, or below the supporting body 16.

In embodiments of the mounting arrangement 20 comprising three collars 48, the connecting the at least one collar 48 to the structure 18 comprises connecting two of the three collars 48 to the supporting body 16 and connecting one of the three collars 48 to the mesh 14, and the arranging the at least one collar 48 about the monopole 12 comprises arranging the three collars 48 at respective spaced positions along the monopole 12, one of the respective spaced positions being above the supporting body 16, another one of the respective spaced positions being substantially in register with the supporting body 16, and the other of the respective spaced positions being below the supporting body 16.

In some embodiments, the mounting the structure 18 about the monopole 12 and above the surface comprises raising at least the supporting body 16 above the surface. It will be understood that the raising may be comprise raising at least the supporting body 16 positioned about the monopole 12 above the surface, and that the raising may comprise raising the supporting body 16 and the connected mesh 14 forming the structure 18, and optionally, the connected mounting arrangement 20, above the surface. It will also be understood that the raising at least the supporting body 16 above the surface may be implemented as a part of the method 100 in any order, such as prior to the positioning 102 the structure 18 about the monopole 12.

The raising at least the supporting body 16 above the surface may be implemented by raising at least the supporting body 16 to a particular height above the surface. For example, a safety cone may be defined between a minimum required circular exclusion zone on the surface and the top 66 of the monopole 12. The particular height may be selected by determining a position along the monopole 12, i.e. the particular height, at which the substantially circular supporting body 16 would substantially coincide with a cross section of the safety cone and be parallel with the minimum required circular exclusion zone on the surface, so as to form a conical frustum between the minimum required circular exclusion zone on the surface and the substantially circular supporting body 16.

This particular height may be based on a predetermined ratio between the radii of the larger circular exclusion zone and the smaller substantially circular supporting body 16. For example, the predetermined ratio may be 4:1, therefore the substantially circular supporting body 16 would be configured to define a radius that is a quarter of the radius of the minimum required circular exclusion zone on the surface and would be raised to the particular height above the surface in order to define a frustum of the safety cone.

A formula is provided below to calculate the particular height h at which to safely raise the supporting body 16 above the surface based on the similar triangle relationship between the right-angled triangle defined between the minimum required circular exclusion zone on the surface and the top 66 of the monopole 12, and the right-angled triangle defined between the substantially circular supporting body 16 and the top 66 of the monopole 12:

$$h = \frac{HR}{r + R} \qquad ( 1 )$$

Where:
H is a total height of the monopole 12;
R is a radius of the minimum required circular exclusion zone on the surface; and
r is a radius of the substantially circular supporting body 16.

If the predetermined ratio of radii is defined as

$$\frac{R}{r} = a$$

and is substituted into (1), another formula to calculate the particular height h at which to safely raise the supporting body 16 above the surface may be provided:

$$h = \frac{aH}{a + 1} \qquad ( 2 )$$

Thus, (2) provides a means to calculate h by only requiring the total height H of the monopole 12 and the ratio of radii a of the minimum required circular exclusion zone on the surface R and the substantially circular supporting body 16 r to be known. For example, if the total height of the monopole 12 is 100 metres and the ratio of radii is 4:1, i.e., a=4, then h would be 80 metres according to (2). In this way, the safety system 10 is able to inhibit the implementation of an exclusion zone on the surface by providing a suitable and safe replacement which provides the same effect as the exclusion zone when the supporting body 16 is raised to a height above the surface that corresponds to the radius of the supporting body 16.

In embodiments of the mounting arrangement 20 comprising the at least one sling, the mounting 104 the structure 18 about the monopole 12 and above the surface comprises arranging the at least one sling about the monopole 12 such that the free end of the at least one sling passes through the eyelet of the at least one sling. In embodiments of the safety system 10 comprising the shielding portion 68, the method 100 further comprises connecting the shielding portion 68 along the periphery 70 of the supporting body 16.

It will be understood that in some embodiments, the raising of at least the supporting body 16 above the surface may be implemented from the surface using the hoisting mechanism, and that operations, such as arranging the at least one collar 48 about the monopole 12 or attaching the mesh 14 to the supporting body 16, may be conducted while at least the supporting body 16 is above the surface by a user operating an aerial work platform.

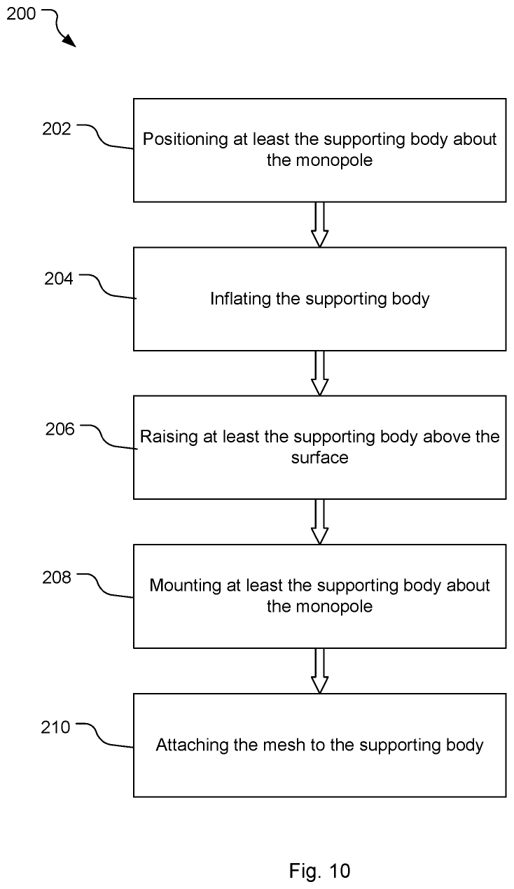

FIG. 10 shows a flowchart of another embodiment of a method 200 of installing the safety system 10 to the monopole 12. It will be understood that the method 200 is only one example embodiment of a method of installing the safety system 10, and that the features of the method 200 may be implemented in any order and may include more or fewer of the features described above in other embodiments.

The method 200 comprises positioning 202 at least the supporting body 16 of the safety system 10 about the monopole 12. In this embodiment, the supporting body 16 is inflatable and the method 200 further comprises inflating 204 the supporting body 16. The method 200 further comprises raising 206 the supporting body 16 positioned about the monopole 12 above the surface, for example, using the hoisting mechanism described above. It will be understood that the raising 206 at least the supporting body 16 above the surface may be implemented as a part of the method 200 in any order, such as prior to the positioning 202 the structure 18 about the monopole 12 and/or prior to the inflating 204 the supporting body 16.

In some embodiments, the positioning 202 comprises positioning only the supporting body 16 about the monopole 12. In some embodiments, the positioning 202 comprises positioning the supporting body 16 with the mesh 14 partially attached to the supporting body 16 about the monopole 12, which requires the attaching of the mesh 14 to the supporting body 16 as discussed below to be partially performed prior to the positioning 202. In some embodiments, the positioning 202 comprises positioning the supporting body 16 with the mesh 14 fully attached to the supporting body 16 about the monopole 12, which requires the attaching of the mesh 14 to the supporting body 16 as discussed below to be performed prior to the positioning 202.

In some embodiments, the raising 206 comprises raising only the supporting body 16 above the surface. In some embodiments, the raising 206 comprises raising the supporting body 16 with the mesh 14 partially attached to the supporting body 16 above the surface, which requires the attaching of the mesh 14 to the supporting body 16 as discussed below to be partially performed prior to the raising 206. In some embodiments, the raising 206 comprises raising the supporting body 16 with the mesh 14 fully attached to the supporting body 16 above the surface, which requires the attaching of the mesh 14 to the supporting body 16 as discussed below to be performed prior to the raising 206. The method 200 further comprises mounting 208 at least the supporting body 16 about the monopole 12 using the mounting arrangement 20. The mounting 208 at least the supporting body 16 about the monopole 12 may include arranging one, two, or three collars 48 about the monopole 12 as described above, or arranging more than three collars 48 about the monopole 12 in a similar manner. The mounting 208 at least the supporting body 16 about the monopole 12 may alternatively or additionally comprise tying or attaching or positioning or securing the second periphery 42 of the mesh 14 about or around the monopole 12 using either the at least one sling connected to the second periphery 42 of the mesh 14 or the eyelets 47 defined at the second periphery 42 of the mesh 14 as described above. In some embodiments, the mounting 208 comprises mounting only the supporting body 16 about the monopole 12. In some embodiments, the mounting 208 comprises mounting the supporting body 16 with the mesh 14 partially attached to the supporting body 16 about the monopole 12, which requires the attaching of the mesh 14 to the supporting body 16 as discussed below to be partially performed prior to the mounting 208. In some embodiments, the mounting 208 comprises mounting the supporting body 16 with the mesh 14 fully attached to the supporting body 16 about the monopole 12, which requires the attaching of the mesh 14 to the supporting body 16 as discussed below to be performed prior to the mounting 208.

The method 200 further comprises attaching 210 the mesh 14 to the supporting body 16. It will be understood that the mesh 14 may be attached 210 to the supporting body 16 while the supporting body 16 is above the surface, or before the supporting body 16 is raised above the surface such that both the supporting body 16 and the attached mesh 14 are able to be raised above the surface simultaneously.

In use, the structure 18 of the safety system 10 is mounted about the monopole 12, for example a monopole of a mobile phone or cell tower, and above the surface, such as the ground, using the mounting arrangement 20 of the safety system 10. This is achieved by implementing any of the methods 100, 200 of installing the safety system 10 described above, and optionally including one or more of the optional features of the methods 100, 200, before maintenance is commenced on the mobile phone or cell tower.

To commence maintenance, maintenance personnel begin climbing or ascending the monopole 12 towards the telecommunication equipment at the top 66 of the monopole 12 to perform maintenance on the telecommunication equipment. While climbing, the maintenance personnel encounter the safety system 10 and operate the zip fastener connecting the opposed ends 44, 46 of the mesh 14 together in an operatively upwards direction or towards the first periphery 40 of the mesh 14 in order to disconnect the ends 44, 46 of the mesh 14. The maintenance personnel are then able to pass through the mesh 14 between the opposed ends 44, 46 and then reconnect the opposed ends 44, 46 of the mesh 14 using the zip fastener before continuing to climb the monopole 12 in order to reach the telecommunication equipment at the top 66 of the monopole 12. Alternatively, the maintenance personnel may be elevated directly to the top 66 of the monopole 12 without being required to climb the monopole 12 and pass through the mesh 14, such as by using an aerial work platform.

While maintenance is being conducted, objects such as tools, telecommunication components, personal items of the maintenance personnel including portable electronic devices and keys, fasteners, and the like may fall from either the top 66 of the monopole 12 or from the maintenance personnel at the top 66 of the monopole 12. The safety system 10 is at a sufficient height above the surface for the mesh 14 to provide a sufficient surface area such that the objects strike the mesh 14 and are carried by the mesh 14, thereby arresting the falling objects and preventing the objects from reaching the ground below. The objects carried by the mesh 14 are then able to be safely removed from the mesh 14 by a user operating an aerial work platform or by the maintenance personnel while climbing down or descending the monopole 12.

After maintenance has been completed, the maintenance personnel begin climbing down from the top 66 of the monopole 12 towards the ground. Upon reaching the safety system 10, the maintenance personnel operate the zip fastener to disconnect the opposed ends 44, 46 of the mesh 14 and pass through the mesh 14. After passing through the mesh 14 the maintenance personnel may optionally reconnect the opposed ends 44, 46 of the mesh 14 before continuing to climb down the monopole 12 and reaching the ground. Alternatively, the maintenance personnel may descend directly from the top 66 of the monopole 12 to the ground using an aerial work platform.

Once the maintenance personnel have completed the maintenance and are no longer on the monopole 12, the safety system 10 is uninstalled from the monopole 12 by a user on an aerial work platform, and may be descended to the ground by a user on the ground operating the hoisting mechanism.

The adjustability of the adjustable supporting body 16 allows the adjustable supporting body 16 to be positioned about monopoles of different widths or diameters, as opposed to a rigid supporting body which is only able to be installed to monopoles of predetermined widths or diameters. The adjustability of the adjustable supporting body 16 also allows the adjustable supporting body 16 to be arranged about the monopole 12 from proximate the surface that the monopole 12 is fixed to, such as the ground, a platform, indoor flooring, a roof, and the like. This simplifies the arrangement of the adjustable supporting body 16 about the monopole 12 for mounting the adjustable supporting body 16 about the monopole 12 as opposed to a substantially rigid supporting body that is required to be arranged over the top 66 of the monopole 12 such that the monopole 12 passes through a hole formed by the rigid supporting body.

The adjustable supporting body 16 allows for easier transportation by being able to be adjusted to form a smaller overall profile than the profile of the adjustable supporting body 16 in use, as opposed to a substantially rigid supporting body which must be transported in its usable form. The adjustable supporting body 16 also increases the structural strength of the safety system 10 by supporting the mesh 14 continuously about the periphery of the mesh 14, as opposed to, for example, implementing supports at discrete locations about the periphery of the mesh 14. This increased structural strength is beneficial in the event that the safety system 10 is subjected to environmental conditions such as wind, rain, hail, and the like.

The mesh 14 allows for falling objects to be arrested or caught by the mesh 14, while inhibiting the effect of environmental conditions such as wind and rain by allowing the wind and rain to pass through the openings of the mesh 14.

The embodiment of the adjustable supporting body 16 being inflatable, which in this embodiment defines the adjustability of the adjustable supporting body 16, allows for a lighter supporting body 16, thereby allowing the raising of at least the supporting body 16 above the surface to be easier as opposed to a supporting body made of metal or hard plastic. For example, the inflatable supporting body 16 allows for the entire safety system 10 to be manufactured at a total mass of under 50 kilograms. Further, the inflatability of the supporting body 16 allows for easy transportation by being light, small and flexible in its deflated configuration as opposed to a substantially rigid supporting body. The hoisting mechanism and the overall light construction of the system 10 allows a single user to raise and lower at least the supporting body 16 with respect to the surface without the use of a lifting machine such as a crane.

The embodiment of the supporting body 16 in the form of the inflatable tube 22 having the ends 24, 26 connectable to each other allows for the supporting body 16 to be passed around the monopole 12 and for the ends 24, 26 to be connected to each other from the surface, as opposed to the supporting body 16 being in the form of an inflatable ring which must be passed over the top 66 of the monopole 12, thereby providing increased difficulty in installation and may not fit over the top 66 of the monopole 12 if large telecommunications equipment, such as the plurality of antennas 58, is located at the top 66 of the monopole 12.

The embodiments of the safety system 10 having releasably connectable features allows for ease of transportation as the features may be arranged in an efficient manner to be transported. The releasably connectable features also allow for the supporting body 16 to be raised above the surface either alone or with a variable number of features removably connected thereto. In this way, the total mass to be raised above the surface is minimised or at least reduced, which provides for an easier installation as opposed to the safety system 10 having some or all features being permanently connected to the supporting body 16.

It will be appreciated that the features of the safety system 10 may all be provided as separate components in some embodiments, and that at least one of the components may be integral with one or more of the other components in other embodiments.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A safety system for arresting falling objects about a monopole, the monopole being fixed to a surface, the system comprising:
a structure having a mesh and an adjustable supporting body arrangeable about a periphery of the mesh; and
a mounting arrangement configured to mount the structure about the monopole and above the surface.

2. The safety system of claim 1, wherein the supporting body is inflatable and wherein the supporting body is in the form of an inflatable tube having ends connectable to each other.

3-5. (canceled)

6. The safety system of claim 1, wherein the mesh comprises a first periphery and a second periphery spaced from the first periphery by a pair of opposed ends, the first periphery being releasably connectable to the supporting body, and the second periphery being mountable about the monopole below the supporting body.

7. The safety system of claim 6, wherein the opposed ends of the mesh are releasably connectable to each other via a zip fastener, and wherein the zip fastener is operable towards the second periphery of the mesh to connect the opposed ends to each other.

8. The safety system of claim 6, wherein the structure is mountable about the monopole and above the surface such that the mesh is substantially loose proximate the second periphery.

9. The safety system of claim 1, wherein the mounting arrangement comprises at least one collar arrangeable about the monopole and connectable to the structure.

10. The safety system of claim 9, wherein the mounting arrangement comprises two collars connectable to the supporting body and arrangeable about the monopole at respective spaced positions along the monopole, one of the respective spaced positions being substantially in register with the supporting body and the other of the respective spaced positions being either: above the supporting body, or below the supporting body.

11. The safety system of claim 1, wherein the mounting arrangement comprises at least one sling having a connected end, a free end and an eyelet, the at least one sling being connected to the supporting body or the mesh at the connected end and configured to be arranged about the monopole such that the free end passes through the eyelet.

12. The safety system of claim 1, wherein the supporting body comprises anchoring portions for connecting a hoisting mechanism to raise at least the supporting body above the surface.

13. A method of installing a safety system to a monopole for arresting falling objects about the monopole, the monopole being fixed to a surface, the method comprising:
positioning a structure of the safety system about the monopole, the structure having a mesh and an adjustable supporting body arranged about a periphery of the mesh; and
mounting the structure about the monopole and above the surface using a mounting arrangement of the safety system.

14. The method of claim 13, wherein the supporting body is inflatable, and wherein the method further comprises inflating the supporting body, and wherein the supporting body is in the form of an inflatable tube, and wherein the positioning the structure about the monopole comprises connecting ends of the inflatable tube to each other about the monopole.

15. (canceled)

16. The method of claim 13, wherein the positioning the structure about the monopole comprises positioning at least the supporting body about the monopole.

17. The method of claim 13, wherein the mounting the structure about the monopole comprises mounting at least the supporting body about the monopole.

18. The method of claim 13, wherein the mesh comprises a first periphery and a second periphery spaced from the first periphery by a pair of opposed ends, and wherein the positioning the structure about the monopole comprises releasably connecting the first periphery to the supporting body, and wherein the mounting the structure about the monopole and above the surface comprises mounting the second periphery about the monopole below the supporting body.

19. The method of claim 18, wherein the positioning the structure about the monopole comprises connecting the opposed ends of the mesh to each other by operating a zip fastener towards the second periphery of the mesh.

20. The method of claim 18, wherein the mounting the second periphery about the monopole comprises mounting the second periphery about the monopole such that the mesh is substantially loose proximate the second periphery.

21. The method of claim 13, wherein the mounting arrangement comprises at least one collar, and wherein the mounting the structure about the monopole and above the surface comprises connecting the at least one collar to the structure and arranging the at least one collar about the monopole.

22. The method of claim 21, wherein the mounting arrangement comprises two collars, and wherein the connecting the at least one collar to the structure comprises connecting the two collars to the supporting body, and the arranging the at least one collar about the monopole comprises arranging the two collars at respective spaced positions along the monopole, one of the respective spaced positions being substantially in register with the supporting body and the other of the respective spaced positions being either: above the supporting body, or below the supporting body.

23. The method of claim 13, wherein the mounting the structure about the monopole and above the surface comprises raising at least the supporting body above the surface.

24. The method of claim 13, wherein the mounting arrangement comprises at least one sling having a connected end, a free end and an eyelet, the at least one sling being connected to the supporting body or the mesh at the connected end, and wherein the mounting the structure about the monopole and above the surface comprises arranging the at least one sling about the monopole such that the free end passes through the eyelet.
